(19) United States
(12) Patent Application Publication
(10) Pub. No.: US 2020/0090260 A1
(43) Pub. Date: Mar. 19, 2020

(54) TRAILER RENTAL SYSTEM AND METHOD FOR RENTING TRAILER

(71) Applicant: TOYOTA JIDOSHA KABUSHIKI KAISHA, Toyota-shi (JP)

(72) Inventors: Tetsu TODO, Aichi-gun (JP); Koichi IKEMOTO, Nagoya-shi (JP); Motoki HAMAZAKI, Toyota-shi (JP); Katsuhiko HIROSE, Toyota-shi (JP); Atsushi MIZUTANI, Toyota-shi (JP); Shuntaro KATO, Nagoya-shi (JP); Yohei TANIGAWA, Toyota-shi (JP)

(21) Appl. No.: 16/548,029

(22) Filed: Aug. 22, 2019

(30) Foreign Application Priority Data
Sep. 13, 2018 (JP) 2018-0171216

(51) Int. Cl. G06Q 30/06; H01M 8/04082

(52) U.S. Cl. CPC G06Q 30/0645; B60P 3/22; H01M 2250/10; H01M 8/04201

(57) ABSTRACT

A trailer rental system comprises a trailer station provided with a trailer mounted with a hydrogen tank and a management apparatus configured to manage the trailer, the management apparatus performing rental operation of the trailer in response to a trailer rental request being received from outside.

### CROSS REFERENCE TO RELATED APPLICATIONS

The present application claims priority to Japanese Patent Application No. 2018-171216, filed on Sep. 13, 2018, the contents of which are incorporated herein by reference in their entirety.

### BACKGROUND

### Field

The present disclosure relates to a system and method for renting a trailer mounted with a hydrogen tank.

### Related Art

JP 2018-101592A discloses a fuel cell vehicle equipped with a fuel cell.

However, when a fuel cell vehicle travels in an area in which few hydrogen stations are located, the fuel cell vehicle may not be able to travel due to lack of hydrogen. Also, when an electric vehicle travels a long distance, the electric vehicle may not be able to travel due to lack of electric power. Furthermore, an area where a disaster such as a flood or an earthquake occurred may have a shortage of hydrogen or electric power. A technology capable of eliminating the shortage of hydrogen or electric power in these cases is desired.

### SUMMARY

According to one aspect of the present disclosure, a trailer rental system is provided. The trailer rental system comprises a trailer station provided with a trailer mounted with a hydrogen tank and a management apparatus that manages the trailer, the management apparatus performing rental of the trailer in response to a trailer rental request that has been received from outside.

### BRIEF DESCRIPTION OF THE DRAWINGS

FIG. 1 shows a configuration of a trailer rental system according to an embodiment.

FIG. 2 shows a configuration of a trailer of type A.

FIG. 3 shows a configuration of a trailer of type B.

FIG. 4 shows a configuration of a trailer of type C.

FIG. 5 is a functional block diagram of a fuel cell vehicle and a management apparatus.

FIG. 6 shows a trailer management database.

FIG. 7 is a flowchart showing a procedure for trailer rental processing.

FIG. 8 shows an example of a setting window for a trailer rental request.

### DETAILED DESCRIPTION

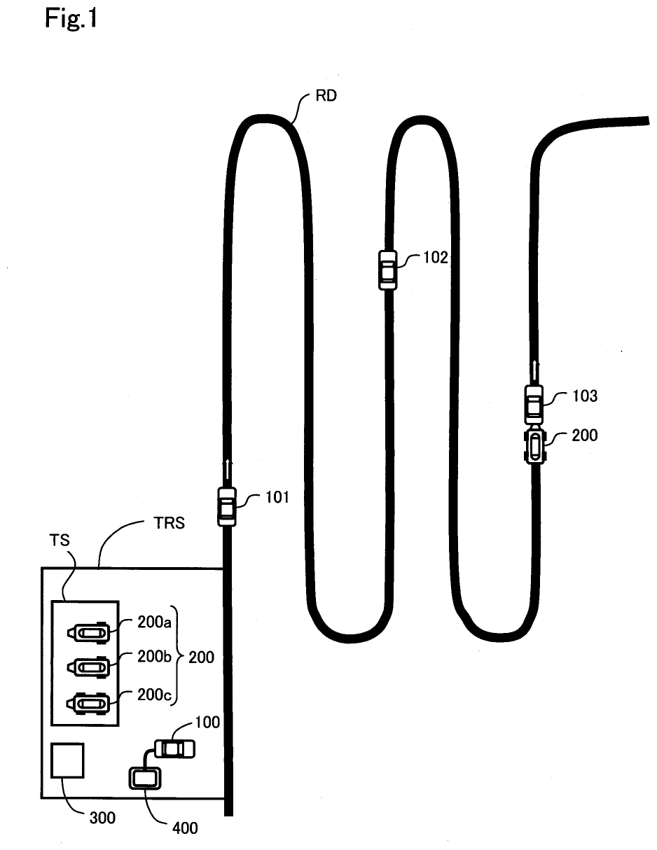

FIG. 1 shows a configuration of a trailer rental system TRS according to an embodiment. The trailer rental system TRS comprises a trailer station TS provided with trailers 200 mounted with a hydrogen tank, a management apparatus 300 that manages the trailers 200, and a hydrogen dispenser 400. The hydrogen dispenser 400 may not be provided. However, the hydrogen dispenser 400 provided in the trailer rental system TRS has an advantage that a hydrogen tank of each of the trailers 200 can be immediately filled with hydrogen as needed.

The trailer rental system TRS is provided at a site along a road RD. FIG. 1 depicts the road RD with a black curved line for convenience of illustration. Three fuel cell vehicles 101 to 103 are shown on the road RD.

The trailer station TS is provided with a plurality of trailers 200. In this example, three types of trailers, a trailer 200a of type A, a trailer 200b of type B, and a trailer 200c of type C, are provided as the trailers 200. Configuration examples of the trailers 200a, 200b, and 200c are described later. When different types of trailers are not distinguished, they are simply referred to as “trailer 200”.

The management apparatus 300 manages the trailers 200 of the trailer station TS. Details of management managed by and rental processing of the trailers 200 performed by the management apparatus 300 are described later.

The hydrogen dispenser 400 refuels the trailers 200 and fuel cell vehicles with hydrogen. The example in FIG. 1 shows the hydrogen dispenser 400 refueling a fuel cell vehicle 100 with hydrogen.

With regard to the three fuel cell vehicles 101 to 103 on the road RD, a first fuel cell vehicle 101 is traveling, a second fuel cell vehicle 102 has stopped traveling due to lack of hydrogen, and a third fuel cell vehicle 103 is traveling towing the trailer 200 rented from the trailer station TS. The second fuel cell vehicle 102 can resume traveling by renting the trailer 200 from the trailer station TS. Hereinafter, when the fuel cell vehicles are not distinguished, they are simply referred to as “fuel cell vehicles 100”.

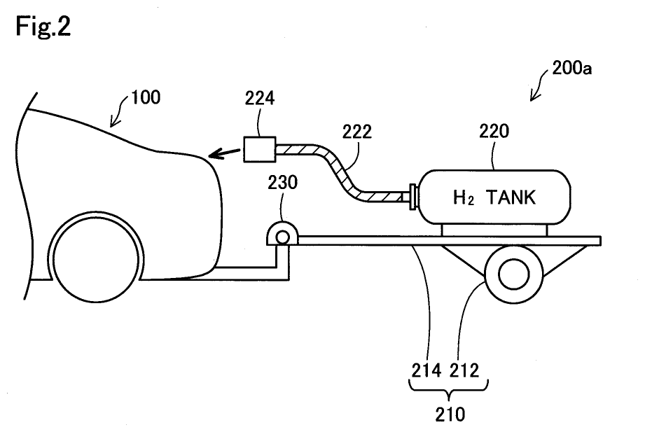

FIG. 2 shows a configuration of the trailer 200a of type A. The trailer 200a has a trailer body 210 including wheels 212 and a chassis 214, and a hydrogen tank 220 mounted above the chassis 214. Two wheels 212 are provided on both sides in the width direction of the trailer 200a. At a head of the chassis 214, a vehicle coupler 230 for coupling a vehicle such as the fuel cell vehicle 100 with the trailer 200a is provided. A hydrogen supply nozzle 224 is connected to the hydrogen tank 220 through a hose 222. The hydrogen supply nozzle 224 is configured to be capable of refueling the fuel cell vehicle 100 with hydrogen.

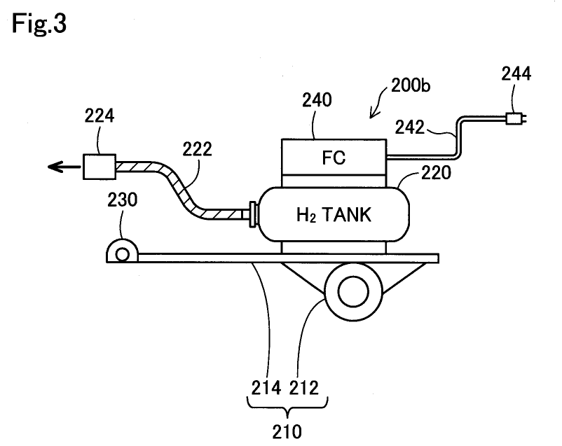

FIG. 3 shows a configuration of the trailer 200b of type B. The trailer 200b of type B differs from the trailer 200a of type A in that the trailer 200b includes a fuel cell system 240 mounted above the chassis 214 in addition to the hydrogen tank 220. The fuel cell system 240 is configured to be capable of generating electric power using hydrogen in the hydrogen tank 220. Note that the figure does not show equipment required for electric power generation such as piping and a pump. The fuel cell system 240 is also simply referred to as “fuel cell 240”. The fuel cell system 240 is provided with an external power connector 244 through a cable 242. The external power connector 244 can supply the electric power generated in the fuel cell system 240 to an electric device such as an electric vehicle. The example in FIG. 3 shows the external power connector 244 having a plug shape, but the external power connector 244 may be configured to have a socket shape.

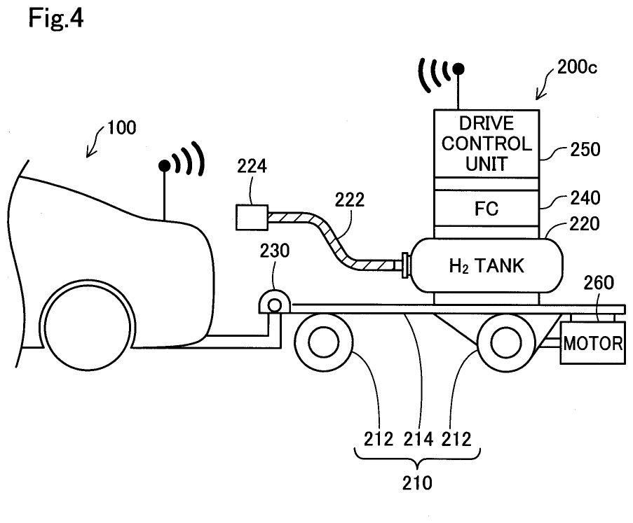

FIG. 4 shows a configuration of the trailer 200c of type C. The trailer 200c of type C has three differences from the trailer 200b of type B in that the trailer 200c includes:

(1) a drive control unit 250 mounted above the chassis 214 in addition to the hydrogen tank 220 and the fuel cell system 240;
(2) the wheels 212 further provided at a fore part of the chassis 214; and
(3) a motor 260 provided for driving the wheels 212.

The drive control unit 250 can drive the wheels 212 using the motor 260, thereby causing the trailer 200c to travel by itself. The drive control unit 250 is preferably configured to be capable of communicating with the fuel cell vehicle 100 and the management apparatus 300 of the trailer rental system TRS using a wireless communication device (not shown). Also, the drive control unit 250 is preferably configured to be capable of autonomous driving. The drive control unit 250 and the motor 260 constitute a drive unit for the trailer 200c. For performing autonomous driving, the trailer 200c is configured to include various devices needed for autonomous driving such as autonomous sensors (such as cameras and radars), steering devices, and braking devices. Although not shown in FIG. 4, the trailer 200c of type C also preferably includes the external power connector 244 described with reference to FIG. 3.

Each three types of trailers 200a, 200b and 200c is mounted with the hydrogen tank 220, and thus is capable of supplying hydrogen to the fuel cell vehicle 100 and other hydrogen utilizing apparatuses such as a stationary fuel cell. Therefore, when the fuel cell vehicle 100 or the stationary fuel cell is running out of hydrogen, or when an area where a disaster occurred has a shortage of hydrogen, each type of the trailers 200 can eliminate the shortage of hydrogen.

When an electric vehicle is running out of electric power, or when a fuel cell cannot meet power demand, or when an area where a disaster occurred has a power shortage, the trailer 200b of type B and the trailer 200c of type C have the external power connector 244, and thus are capable of eliminating the power shortage.

The trailer 200c of type C comprises the drive unit including the drive control unit 250 and the motor 260, and thus is capable of EV-traveling by itself and supplying hydrogen or electric power to the fuel cell vehicle 100 and the electric vehicle. Also, the trailer 200c of type C coupled with a 2WD vehicle is provided with similar driving power to a 4WD vehicle, and thus is capable of increasing roadability on snow and bad roads.

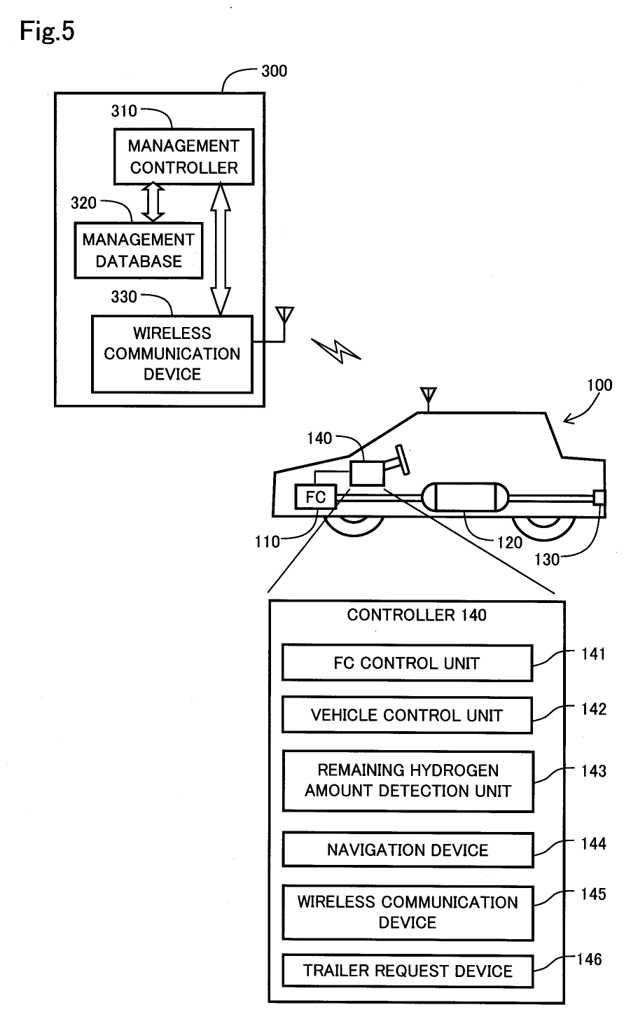

FIG. 5 is a functional block diagram of the fuel cell vehicle 100 and the management apparatus 300 of the trailer rental system TRS. Here, it is assumed that an administrator of the fuel cell vehicle 100 requests the management apparatus 300 of the trailer rental system TRS to rent the trailer 200. The administrator of the fuel cell vehicle 100 may be, for example, a driver of the fuel cell vehicle 100.

The management apparatus 300 includes a management controller 310, a management database 320, and a wireless communication device 330. The management controller 310 can be implemented, for example, in a computer including a processor and a memory. The management database 320 is a database for managing the trailers 200 of the trailer station TS. An example of a configuration of the management database 320 is described later. The wireless communication device 330 is used to communicate with the fuel cell vehicle 100, the trailer 200c of type C, and the like described with reference to FIG. 4.

The fuel cell vehicle 100 includes a fuel cell system 110, a hydrogen tank 120, a receptacle 130 to which the hydrogen supply nozzle 224 described with reference to FIG. 2 is connected, and a controller 140.

The controller 140 can be implemented, for example, in a computer including a processor and a memory. The controller 140 includes an FC control unit 141 that controls the fuel cell system 110, a vehicle control unit 142 that controls traveling of the fuel cell vehicle 100, a remaining hydrogen amount detection unit 143 that detects a remaining hydrogen amount in the hydrogen tank 120, a navigation device 144, a wireless communication device 145, and a trailer request device 146. Some or all of these units and devices 141 to 146 may be implemented in software or hardware. The administrator of the fuel cell vehicle 100 uses the trailer request device 146 when making a rental request for the trailer 200 to the management apparatus 300. The rental request is described later.

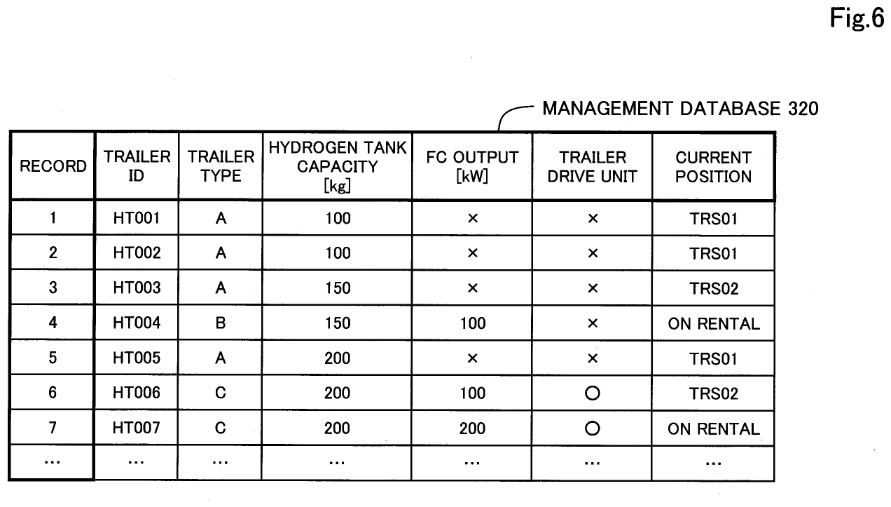

FIG. 6 shows a configuration example of the management database 320 of the trailer 200. In this example, the management database 320 registers items below for each record.

### (1) Trailer ID

“Trailer ID” is an ID for identifying the trailer 200.

### (2) Trailer Type

“Trailer type” indicates either one of the trailer types shown in FIGS. 2 to 4.

### (3) Hydrogen Tank Capacity

“Hydrogen tank capacity” indicates a capacity of the hydrogen tank 220 mounted above the trailer 200.

### (4) FC Output

“FC output” indicates an output power of the fuel cell system 240 of the trailer 200b of type B and the trailer 200c of type C.

### (5) Trailer Drive Unit

“Trailer drive unit” indicates whether each trailer 200 is provided with the drive control unit 250 and the motor 260 described with reference to FIG. 4.

### (6) Current Position

“Current position” indicates where each trailer 200 currently exists. For example, “TRS01” as “current position” of a trailer 200 indicates that the trailer exists at a trailer station of which station ID is “TRS01”. Also, “on rental” as “current position” of a trailer 200 indicates that the trailer is on rental.

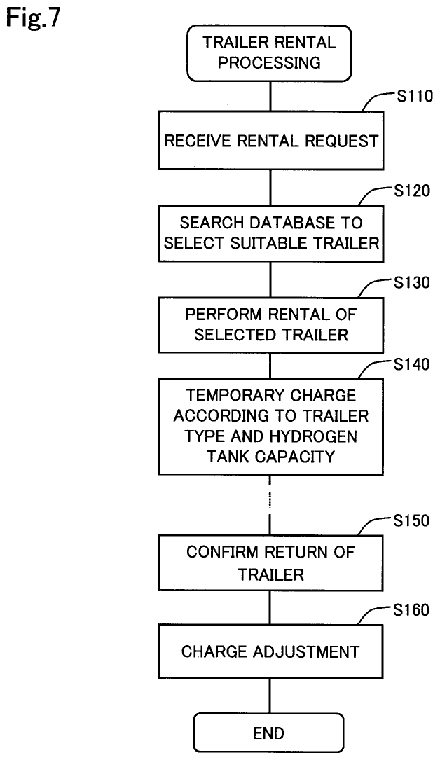

FIG. 7 is a flowchart showing a procedure for rental processing of the trailer 200. Here, it is assumed that the management apparatus 300 receives a rental request for the trailer 200 from the administrator of the fuel cell vehicle 100 shown in FIG. 5.

In step S110, the management apparatus 300 receives a rental request for the trailer 200 from outside. For example, when the administrator of the fuel cell vehicle 100 sets a rental request for the trailer 200 using the trailer request device 146 shown in FIG. 5, the rental request is transmitted from the trailer request device 146 to the management apparatus 300 in accordance with the set rental request. Note that the management apparatus 300 can receive a rental request for the trailer 200 also from a device other than the fuel cell vehicle 100 and an administrator thereof.

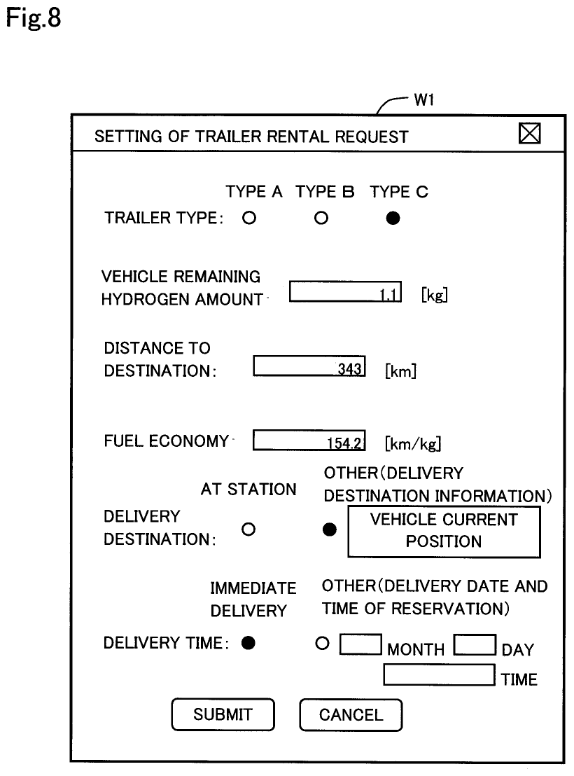

FIG. 8 shows an example of a setting window W1 for a trailer rental request. The trailer request device 146 displays the setting window W1 on a display panel (not shown) in the fuel cell vehicle 100. The rental request for the trailer includes, for example, information below.

### (a) Trailer Type

“Trailer type” is selected, for example, by the administrator of the fuel cell vehicle 100 using the trailer request device 146. For example, when the fuel cell vehicle 100 runs out of hydrogen while traveling as does the fuel cell vehicle 102 in FIG. 1, a selection of type C including the drive control unit 250 and the motor 260 as the trailer type can cause the trailer 200c of type C to travel by itself to a stop position of the fuel cell vehicle 102. Alternatively, when the fuel cell vehicle 100 is scheduled to drop in at the trailer station TS and a trailer 200 is to be reserved in advance, a selection of type A or type B as the trailer type is sufficient.

### (b) Remaining Hydrogen Amount of Fuel Cell Vehicle

“Remaining hydrogen amount of fuel cell vehicle” is an amount of hydrogen remaining in the hydrogen tank 120 of the fuel cell vehicle 100.

### (c) Distance to Destination

“Distance to destination” is a distance from a current position of the fuel cell vehicle 100 to a destination set in the navigation device 144.

### (d) Fuel Economy of Fuel Cell Vehicle 100

“Fuel economy” is a travel distance per unit hydrogen amount of the fuel cell vehicle 100.

### (e) Delivery Destination

“Delivery destination” indicates where to deliver the trailer 200. When “delivery destination” is “at station”, the trailer 200 is not delivered and waits until a sender of the rental request arrives at the trailer station TS. In this case, the trailer rental request is equivalent to a reservation of the trailer 200. “Other” selected as “delivery destination” requires a specification of delivery destination information indicating a specific delivery destination. In the example of FIG. 8, the current position of the fuel cell vehicle 100 is designated as the delivery destination information.

### (f) Delivery Time

“Delivery time” is a time at which the trailer 200 is rented out at the delivery destination. “Immediate delivery” selected as “delivery time” causes the trailer 200 to be delivered as soon as possible. “Other” selected as “delivery time” requires a specification of delivery date and time of the reservation of the trailer 200.

When the administrator presses a “submit” button after completing setting on the setting window W1, a trailer rental request including set information is transmitted from the trailer request device 146 of the fuel cell vehicle 100 to the management apparatus 300.

The various information included in the trailer rental request described with reference to FIG. 8 is an example, and some portion of the information may be removed, or other information may be added. For example, in addition to the information described above, the trailer rental request may include an ID of the fuel cell vehicle 100 or an ID of the administrator of the fuel cell vehicle 100.

Upon receipt of the trailer rental request, in step S120 in FIG. 7, the management device 300 searches the management database 320 described with reference to FIG. 6 to select a trailer 200 that meets the trailer rental request. Specifically, for example, a hydrogen amount in the hydrogen tank 220 of the trailer 200 is set to a required hydrogen amount or more determined from the trailer rental request. For example, when the trailer rental request is set as shown in FIG. 8, the required hydrogen amount can be calculated with a following equation.

Req=D/M−Res+α (1),

where Req is the required hydrogen amount [kg], D is the distance to destination [km], M is the fuel economy [km/kg], Res is the remaining hydrogen amount of the fuel cell vehicle 100 [kg], and α is a fixed value added as a margin.

In a typical example, a trailer 200 is rented out with the hydrogen tank 220 full. In this case, a trailer 200 mounted with a hydrogen tank 220 having a capacity of the required hydrogen amount Req or more is selected as the trailer 200 that meets the trailer rental request. Instead, although the hydrogen tank 220 of the trailer 200 is not filled up, a trailer 200 of which the hydrogen tank 220 contains a hydrogen amount not less than the required hydrogen amount Req may be selected as a rentable one.

In step S130, the management apparatus 300 performs rental of the selected trailer 200. For example, for the fuel cell vehicle 102 shown in FIG. 1, which cannot travel because of lack of hydrogen on the road RD, the trailer 200 may be delivered, or travel by itself, to the current position of the fuel cell vehicle 102 to perform the rental. When the delivery destination of the trailer 200 is specified in the trailer rental request, the trailer 200 is delivered to the delivery destination to perform the rental. When the delivery date and time of the reservation is specified in the trailer rental request, delivery and renting of the trailer 200 are performed at the delivery date and time of the reservation.

In step S140, the management apparatus 300 performs temporary charging according to the trailer type and the capacity of the hydrogen tank 220 of the trailer 200 rented out. For example, the three types of trailers 200a, 200b, and 200c described with reference to FIGS. 2 to 4 are well equipped in this order, and thus are configured to cause a high fee in this order. Also, the management apparatus 300 is configured to charge a higher fee as the capacity of the hydrogen tank 220 increases. In step S140, the management apparatus 300 may charge according to either one of the trailer type and the capacity of the hydrogen tank 220. Thus, in step S140, appropriate rental fees can be set according to at least one of the trailer type and the capacity of the hydrogen tank 220.

When the administrator of the fuel cell vehicle 100 returns the trailer 200 and the management apparatus 300 confirms the return in step S150, charge adjustment is performed in step S160. The charge adjustment is performed, for example, according to an amount of hydrogen actually consumed. In the charge adjustment of step S160, a billed amount may be exactly a same as the temporary charge amount set in step 140.

As described above, when hydrogen or electric power runs short, the trailer rental system TRS according to the present embodiment rents the trailer 200 mounted with the hydrogen tank 220, and thus is capable of eliminating the shortage of hydrogen or electric power.

The hydrogen dispenser 400 may not be provided for the trailer rental system TRS described with reference to FIG. 1. In this case, placing the trailers 200 in the trailer station TS with the hydrogen tank 220 of each trailer 200 having been filled up at an external hydrogen station keeps the trailers 200 always ready for rental. Also, not providing the hydrogen dispenser 400 can eliminate auxiliary equipment needed for hydrogen dispenser 400 and construction thereof, and thus is capable of simplifying the configuration of the trailer rental system TRS.

The present disclosure is not limited to the above-described embodiment, examples, and modifications, and various modifications may be made without departing from the scope of the present disclosure. For example, the technical features described in the embodiment can be appropriately replaced or combined so as to solve some or all of the problems described above or achieve some or all of the effects described above. The technical features may be appropriately removed unless described as essential in the present specification. For example, the present disclosure may be implemented according to aspects described below.

(1) According to one aspect of the present disclosure, a trailer rental system is provided. The trailer rental system comprises a trailer station provided with a trailer mounted with a hydrogen tank and a management apparatus configured to manage the trailer, the management apparatus performing rental operation of the trailer in response to a trailer rental request being received from outside.

When hydrogen or electric power runs short, the trailer rental system rents the trailer mounted with the hydrogen tank, and thus is capable of eliminating the shortage of hydrogen or electric power.

(2) In the trailer rental system described above, the trailer may be mounted with a fuel cell configured to generate electric power using hydrogen from the hydrogen tank, and an external power connector configured to output the electric power generated in the fuel cell to outside.

The trailer rental system enables the trailer also to be used as a power supply, and thus is capable of eliminating the shortage of hydrogen or electric power.

(3) In the trailer rental system described above, the trailer may be mounted with a fuel cell configured to generate electric power using hydrogen from the hydrogen tank, and a drive unit that causes the trailer to travel using the electric power generated in the fuel cell.

In the trailer rental system, the trailer can travel by itself, and thus is capable of traveling to a destination.

(4) In the trailer rental system described above, a hydrogen amount in the hydrogen tank of the trailer to be rented out by the management apparatus may be set to a required hydrogen amount or more determined from the trailer rental request.

In the trailer rental system, the trailer having the hydrogen amount more than the required hydrogen amount determined from the trailer rental request is rented out, and thus is capable of supplying sufficient hydrogen.

(5) In the trailer rental system described above, the management apparatus may calculate a fee at renting out according to a capacity of the hydrogen tank of the trailer to be rented out by the management apparatus.

In the trailer rental system, appropriate rental fees can be determined according to the capacity of the hydrogen tank.

(6) Another aspect of the present disclosure provides a method of renting a trailer in a system including a trailer station provided with a trailer mounted with a hydrogen tank and a management apparatus configured to manage the trailer. The method comprises receiving a trailer rental request from outside, and performing rental of the trailer in response to the trailer rental request being received.

With this method, when hydrogen or electric power runs short, the trailer mounted with the hydrogen tank can be rented, thereby eliminating the shortage of hydrogen or electric power.

(7) In the method described above, the trailer may be mounted with a fuel cell configured to generate electric power using hydrogen from the hydrogen tank and an external power connector configured to output the electric power generated in the fuel cell to outside.

The method enables the trailer also to be used as a power supply, and thus is capable of eliminating the shortage of hydrogen or electric power.

(8) In the method described above, the trailer may be mounted with a fuel cell configured to generate electric power using hydrogen from the hydrogen tank, and a drive unit configured to cause the trailer to travel using the electric power generated in the fuel cell.

By using the method, the trailer can travel by itself, and thus is capable of traveling to a destination.

(9) The method may further comprise setting a hydrogen amount in the hydrogen tank of the trailer to be rented out by the management apparatus to a required hydrogen amount or more determined from the trailer rental request.

By using the method, the trailer having the hydrogen amount more than the required hydrogen amount determined from the trailer rental request is rented out, and thus is capable of supplying sufficient hydrogen.

(10) The method may further comprise calculating a fee at renting out according to a capacity of the hydrogen tank of the trailer to be rented out by the management apparatus.

By using the method, appropriate rental fees can be determined according to the capacity of the hydrogen tank.

The present disclosure may be implemented by various aspects, for example, the trailer rental system, the management apparatus and a management method of the trailer rental system, and the like.

What is claimed is:

1. A trailer rental system comprising:
a trailer station provided with a trailer mounted with a hydrogen tank; and
a management apparatus configured to manage the trailer, the management apparatus performing rental operation of the trailer in response to a trailer rental request being received from outside.

2. The trailer rental system according to claim 1, wherein the trailer is mounted with
a fuel cell configured to generate electric power using hydrogen from the hydrogen tank, and
an external power connector configured to output the electric power generated in the fuel cell to outside.

3. The trailer rental system according to claim 1, wherein the trailer is mounted with
a fuel cell configured to generate electric power using hydrogen from the hydrogen tank, and
a drive unit configured to cause the trailer to travel using the electric power generated in the fuel cell.

4. The trailer rental system according to claim 1, wherein a hydrogen amount in the hydrogen tank of the trailer to be rented out by the management apparatus is set to a required hydrogen amount or more determined from the trailer rental request.

5. The trailer rental system according to claim 1, wherein the management apparatus calculates a fee at renting out according to a capacity of the hydrogen tank of the trailer to be rented out by the management apparatus.

6. A method of renting a trailer in a system including a trailer station provided with a trailer mounted with a hydrogen tank and a management apparatus configured to manage the trailer, the method comprising:
receiving a trailer rental request from outside; and
performing rental of the trailer in response to the trailer rental request being received.

7. The method according to claim 6, wherein the trailer is mounted with
a fuel cell configured to generate electric power using hydrogen from the hydrogen tank, and
an external power connector configured to output the electric power generated in the fuel cell to outside.

8. The method according to claim 6, wherein the trailer is mounted with
a fuel cell configured to generate electric power using hydrogen from the hydrogen tank, and
a drive unit configured to cause the trailer to travel using the electric power generated in the fuel cell.

9. The method according to claim 6, the method further comprising setting a hydrogen amount in the hydrogen tank of the trailer to be rented out by the management apparatus to a required hydrogen amount or more determined from the trailer rental request.

10. The method according to claim 6, the method further comprising calculating a fee at renting out according to a capacity of the hydrogen tank of the trailer to be rented out by the management apparatus.
